(19) United States
(12) Patent Application Publication
(10) Pub. No.: US 2015/0363804 A1
(43) Pub. Date: Dec. 17, 2015

(54) LEAD ANALYSIS BASED ON PATH DATA

(71) Applicant: Google Inc., Mountain View, CA (US)

(72) Inventor: Neil Hoyne, Santa Clara, CA (US)

(73) Assignee: Google Inc., Mountain View, CA (US)

(21) Appl. No.: 14/229,104

(22) Filed: Mar. 28, 2014

(51) Int. Cl. G06Q 30/02

(52) U.S. Cl. CPC G06Q 30/0206

(57) ABSTRACT

Systems, methods, and computer-readable storage media that may be used to evaluate leads based on path data are provided. One method includes receiving lead data and determining path data representing one or more paths including one or more interactions leading to submission of the lead data. The method further includes determining a cost metric representing a cost to a content provider of the one or more interactions leading to submission of the lead data, a delay metric between a first interaction of the one or more interactions and submission of the lead data, and an engagement metric relating to a level of engagement of the device identifier with one or more resources associated with the content provider prior to submission of the lead data. The method further includes generating an effort score based on a combination of the cost metric, the delay metric, and the engagement metric.

### BACKGROUND

Content providers (e.g., businesses) often receive lead information from potential customers that may be used in presenting marketing information to the customers with the goal of having the customers purchase items (e.g., products/services) from the content providers. Such lead data may be received, for instance, through a data submission form placed within a webpage or other resource associated with the content provider. Such leads may give content providers valuable information that can be used to direct marketing materials to the potential customers and/or customize the information provided to the potential customers based on the information they have provided through the leads. However, following up on leads requires content providers to expend time and resources (e.g., monetary resources) on users who may or may not purchase items from the content providers. It is often difficult for content providers to identify the leads on which to expend resources.

### SUMMARY

One illustrative implementation of the disclosure relates to a method that includes receiving, at a computerized analysis system, lead data and determining, by the analysis system, path data representing one or more paths including one or more interactions leading to submission of the lead data. The one or more interactions include a device identifier associated with a device. The method further includes determining, by the analysis system, a cost metric representing a cost to a content provider of the one or more interactions leading to submission of the lead data. The method further includes determining, by the analysis system, a delay metric between a first interaction of the one or more interactions and submission of the lead data. The method further includes determining, by the analysis system, an engagement metric relating to a level of engagement of the device identifier with one or more resources associated with the content provider prior to submission of the lead data. The method further includes generating, by the analysis system, an effort score based on a combination of the cost metric, the delay metric, and the engagement metric.

Another implementation relates to a system including at least one computing device operably coupled to at least one memory. The at least one computing device is configured to receive lead data and determine path data representing one or more paths including one or more interactions leading to submission of the lead data. The one or more interactions include a device identifier associated with a device. The at least one computing device is further configured to determine a cost metric representing a cost to a content provider of the one or more interactions leading to submission of the lead data, a delay metric between a first interaction of the one or more interactions and submission of the lead data, and an engagement metric relating to a level of engagement of the device identifier with one or more resources associated with the content provider prior to submission of the lead data. The at least one computing device is further configured to generate an effort score based on a combination of the cost metric, the delay metric, and the engagement metric.

Yet another implementation relates to one or more computer-readable storage media having instructions stored thereon that, when executed by at least one processor, cause the at least one processor to perform operations. The operations include receiving lead data and determining path data representing one or more paths including one or more interactions leading to submission of the lead data. The one or more interactions include a device identifier associated with a device. The operations further include determining a cost metric representing a cost to a content provider of the one or more interactions leading to submission of the lead data. The cost metric is determined based on one or more interaction costs of one or more of the interactions obtained from the path data, and, when the path data includes a plurality of interaction costs, determining the cost metric includes aggregating the plurality of interactions costs. The operations further include determining a delay metric between a first interaction of the one or more interactions and submission of the lead data. The delay metric includes at least one of a time delay between the first interaction and submission of the lead data or a number of interactions between the first interaction and submission of the lead data. The operations further include determining an engagement metric relating to a level of engagement of the device identifier with one or more resources associated with the content provider prior to submission of the lead data. The engagement metric is determined based on at least one of a number of interactions prior to submission of the lead data, an interaction time associated with one or more of the interactions, or a total interaction time associated with the one or more interactions. The operations further include generating an effort score based on a combination of the cost metric, the delay metric, and the engagement metric. The operations further include providing a recommendation regarding whether the content provider should take one or more actions with respect to the lead data based on the effort score.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for generating an effort score for a lead according to an illustrative implementation.

FIG. 3 is a flow diagram of a process for determining weighting values to be used in generating an effort score for a lead based on input from a content provider according to an illustrative implementation.

FIG. 4 is a flow diagram of a process for modifying the weighting values determined using the process of FIG. 3 based on a lead outcome according to an illustrative implementation.

FIG. 5 is a flow diagram of a process for modifying the weighting values determined using the process of FIG. 3 based on path data characteristics associated with a particular lead outcome according to an illustrative implementation.

FIG. 6 is a flow diagram of a process for determining characteristics to be emphasized when determining the cost/delay/engagement metrics in the process of FIG. 2 based on input from a content provider according to an illustrative implementation.

FIG. 7 is an illustration of path data according to an illustrative implementation.

FIG. 8 is an illustration of a user interface configured to present effort data associated with leads according to an illustrative implementation.

FIG. 9 is a block diagram of a computing system according to an illustrative implementation.

### DETAILED DESCRIPTION

Referring generally to the Figures, various illustrative systems and methods are provided that may be used to evaluate leads received by a content provider. Lead generation is a conversion event allowing a content provider to evaluate online content performance in the absence of an immediate purchase. Lead generation may allow businesses with a more complex sales cycle, such as those in the business-to-business, automotive, and education categories/verticals, to modify (e.g., optimize) their content campaigns in anticipation of an end result. These content providers may aggregate inbound leads and the historical conversion rates for each channel (e.g., display content items displayed within a particular resource, such as a webpage, search-based content items displayed within a search engine interface, etc.) to derive an acceptable cost-per-lead (CPL) by which to determine bids. Some content providers may rely on propensity score models that model expected conversion performance against a number of available inputs from the lead, such as expressed product interests, location, job title, etc.

Both of these techniques have issues. First, it is difficult to collect more information from the user providing the lead data. Increasing the number of questions required from a resource visitor can increase the accuracy of predicting a likelihood of conversion, but may itself decrease the conversion rate. Further, the data behind the underlying customer journey is often narrow. Longer, more complex purchase cycles often require multiple interactions with a customer. In some education-related implementations, for instance, the process may take up to 18 months for a new student. Techniques utilized by content providers may only allow the content provider to capture the last click associated with the new lead (e.g., the last click before submission of the lead data), neglecting the inferences that can be assigned by knowing proper position in the sales/interaction cycle. With such narrow data, content providers may not be able to discern how much effort has been made on the part of the content provider prior to the last click in interacting with the user prior to receiving the lead, or how engaged the user is with the content provider (which may indicate how likely following up on the lead is to result in a purchase). In some implementations, content providers may ask users to self-report their last contact point to account for offline influence (e.g., asking users whether they saw/heard a television/radio item), which may lead to an established bias in the resulting lead data. Additionally, once an acceptable CPL has been established for a channel, content providers may pursue volume over increased efficiency. Resulting conversion data may not be returned or matched to a source lead, limiting the content network's ability to optimize the lead generation process.

This disclosure provides systems and methods for evaluating leads by generating an effort score for the leads. An illustrative analysis system may receive lead data relating to a user and determine user path data. The user path data may include one or more user paths that include user interactions leading to submission of the lead data. The analysis system may determine a cost metric representing a cost to the content provider of the interactions with the user leading to the submission of the lead data. The analysis system may also determine a delay metric between the first interaction with the user and submission of the lead data, such as an amount of time or number of interactions between the first interaction and the lead submission. The analysis system may determine an engagement metric relating to engagement of the user with resources associated with the content provider prior to submission of the lead, such as a number of interactions (e.g., number of resources, such as webpages, visited and/or number of interactions, such as impressions viewed and/or clicks made on content items) with resources associated with the content provider, amount of time spent interacting with one or more of the resources, total amount of time spent over the course of multiple interactions, etc. In some implementations, the cost metric, delay metric, and/or engagement metric may be determined based on data reflected in the user path data. In some implementations, additional metrics may be utilized to generate the effort scores for the leads, such as demographic data (e.g., age, gender, interest categories, etc.) and/or location data (e.g., region of world, distance from a store, etc.).

The analysis system may generate an effort score based on a combination of the cost metric, the delay metric, and the engagement metric. The effort score may be representative of an amount of effort invested in pursuing the lead by the time the lead data is received and/or an amount of effort invested by the user associated with the lead data in engaging with the content provider prior to submitting the lead data. In some implementations, the effort score may be generated based on a weighted combination of the metrics, such that some of the metrics may be given greater weight in determining the effort score. In some such implementations, the weighting may be based on content provider input. In some implementations, one or more of the metrics may have multiple characteristics, the one or more of the characteristics may be given greater weight in determining the metric and/or the effort score (e.g., based on content provider input). In one such implementation, if an automotive content provider is aware that customers who view financing information are closer to a purchase than those who view a vehicle building page, the content provider may provide input causing the analysis system to place greater emphasis on interactions with a financing webpage when determining the engagement metric and/or effort score. In some implementations, the analysis system may provide information relating to the effort score (e.g., an indication that the score was high, average, or low) without providing the underlying cost, delay, and engagement metrics. In some implementations, the analysis system may additionally or alternatively provide a recommendation regarding whether the content provider should take one or more actions with respect to the lead data based on the effort score (e.g., contact the user, add the user to a remarketing list, not invest any further resources in pursuing the user at this time, etc.).

In some implementations, the analysis system may be configured to train or customize the process for determining the effort score based on analysis of results for previously received leads. In some such implementations, the analysis system may determine outcomes associated with one or more leads after submission of the lead data (e.g., whether or not the lead resulted in a purchase or other desired converting activity, how long it took for the lead to result in a conversion, etc.). The analysis system may modify the process for determining effort scores for one or more subsequent leads (e.g., modify weighting values associated with one or more of the metrics and/or characteristics of the metrics) based on the outcome. In some implementations, the analysis system may analyze the user path data associated with “good” and/or “bad” leads (e.g., leads that did or did not result in conversions, respectively) and identify one or more types of interactions or interaction characteristics associated with the leads. Based on the identified interactions, characteristics, the effort score determination process may be modified. In one such implementation, if analysis of user path data determines that successful leads frequently include a delay of between 2-3 weeks from a first interaction to a lead submission, analysis system may modify the effort score weighting to give greater weight to those leads that include a delay metric indicating a time delay from first interaction to lead submission of 2-3 weeks.

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

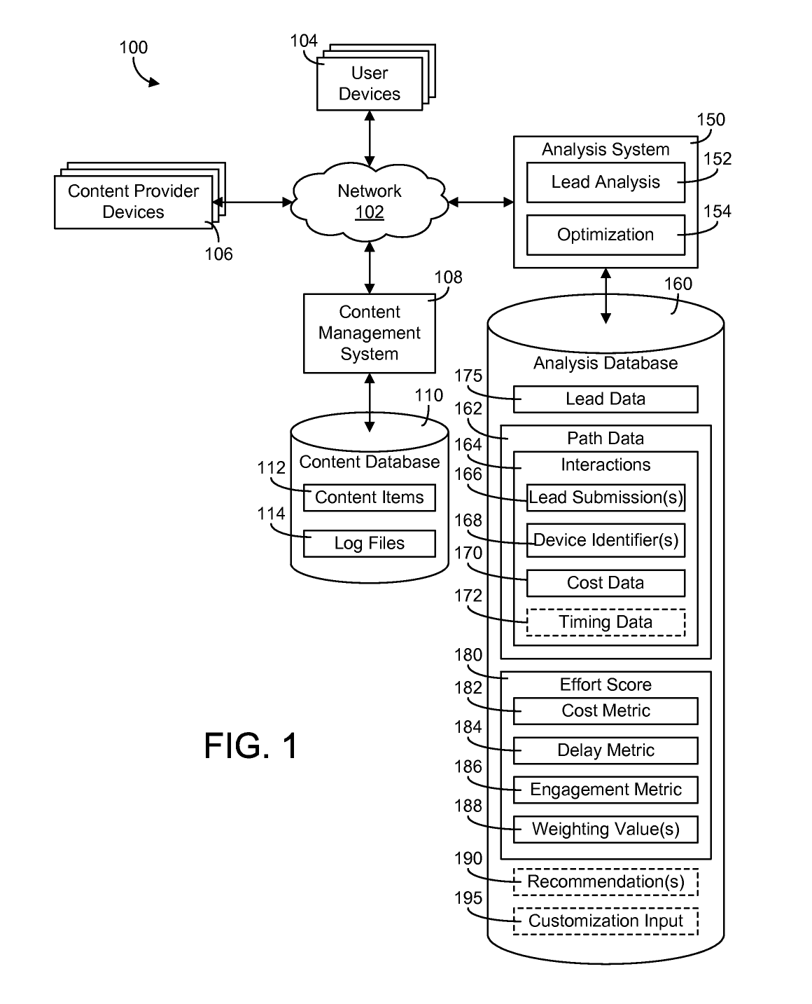

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

At least some content items published by content management system 108 may lead to one or more resources (e.g., webpages) of a content provider. In some implementations, users may be presented with resources that invite the users to enter one or more pieces of lead data 175, such as a name, address, email address, and/or other information. In some implementations, lead data 175 may be transmitted using a form presented to users through a webpage associated with the content provider. In some implementations, lead data 175 may additionally or alternatively be submitted through one or more form fields provided directly within the content items. Lead data 175 may be received by one or more lead handling systems associated with the content provider and/or an agent of the content provider.

An analysis system 150 may be configured to analyze leads received by the user based on path data 162 relating to interactions 164 of user devices 104 leading the submission of lead data 175. Each user path represents one or more interactions of a user with one or more resources (e.g., webpages, applications, etc.) and/or content items (e.g., paid and/or unpaid content items displayed within a resource, such as items displayed within a search engine results interface). One or more of user paths 162 lead to submission of lead data 175.

System 150 may analyze path data 162 to generate an effort score 180 for the lead associated with lead data 175. Effort score 180 may be indicative of a relative effort on the part of the user and/or the content provider reflected in the interactions leading to submission of lead data 175. In some implementations, effort score 180 may be a normalized value (e.g., on a scale of 1-100) that increases based on the relative effort required in capturing the lead for the business and/or the relative effort expended on the part of the user in interacting with resources associated with the content provider. System 150 may determine a cost metric 182 representing a cost to the content provider of the interaction(s) leading to submission of lead data 175 (e.g., a monetary amount spent directing paid content items to the user, such as paid search-based content items displayed within a search results interface and/or paid display-based content items embedded within resources). System 150 may also determine a delay metric 184 between a first interaction and submission of lead data 175 (e.g., a number of interactions and/or elapsed time between the first interaction and the submission of lead data 175). System 150 may also determine an engagement metric 186 relating to a level of engagement of the user device with one or more resources associated with the content provider (e.g., webpages and/or content items relating to the content provider) prior to submission of lead data 175. System 150 may generate effort score 180 based on a combination of cost metric 182, delay metric 184, and engagement metric 186. In some implementations, system 150 may present information based on the generated effort score 180 to the content provider (e.g., whether the effort associated with the lead is high/medium/low) without providing the underlying cost metric 182, delay metric 184, engagement metric 186, and/or any individual user-level data utilized to generate these metrics. In some implementations, system 150 may provide the content provider with a recommendation 190 regarding whether the content provider should take one or more actions with respect to lead data 175 based on effort score 180 (e.g., whether or not the content provider should follow up on the lead).

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to lead data 175 and determine an effort score 180 for one or more leads. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include a lead analysis module 152 configured to analyze path data 162 and generate an effort score 180 for one or more leads associated with lead data 175. Path data 162 may relate to user interactions with one or more items, such as resources (e.g., webpages, applications, etc.) and/or paid or unpaid content items displayed within an interface in a resource (e.g., a search engine interface), leading to a one or more lead submissions 166 of lead data 175.

Lead analysis module 152 may generate effort score 180 based on several factors. Lead analysis module 152 may determine a cost metric 182 representing a cost to the content provider of the interactions leading to a lead submission 166. In some implementations, lead analysis module 152 may determine cost metric 182 based on cost data 170 associated with and/or cross-referenced with one or more interactions 164 of path data 162 (e.g., costs associated with the presentation of paid content items to the user device of the user). Lead analysis module 152 may also determine a delay metric 184 between a first interaction of a path and lead submission 166. In some implementations, delay metric 184 may be a time delay and/or number of interactions between the first interaction and lead submission 166. Lead analysis module 152 may also determine an engagement metric 186 indicative of a level of engagement of the user device with one or more resources associated with the content provider prior to lead submission 166. Lead analysis module 152 may determine effort score 180 based on a combination of cost metric 182, delay metric 184, and engagement metric 186. In some implementations, different weighting values 188 may be applied to the different factors in generating effort score 180. In some such implementations, weighting values 188 may be determined based at least in part on input from the content provider. In some implementations, lead analysis module 152 may provide information based on effort score 180 to a user without providing the underlying cost metric 182, delay metric 184, engagement metric 186, and/or any underlying individualized user data utilized to generate these metrics. In some implementations, lead analysis module 152 may provide one or more recommendations regarding whether the content provider should take any actions with respect to lead data 175.

In some implementations, analysis system 150 may include an optimization module 154 configured to modify one or more parameters used to generate effort scores for leads based on outcomes of one or more leads. In some implementations, optimization module 154 may be configured to determine an outcome associated with a lead (e.g., successful/unsuccessful, for example, based on whether the user subsequently made a purchase) and modify one or more weighting values 188 used to determine subsequent effort scores based on the outcome. In some implementations, optimization module 154 may determine outcomes associated with multiple leads, analyze path data associated with the leads to identify common characteristics associated with a particular outcome, and modify weighting values 188 associated with the identified characteristics.

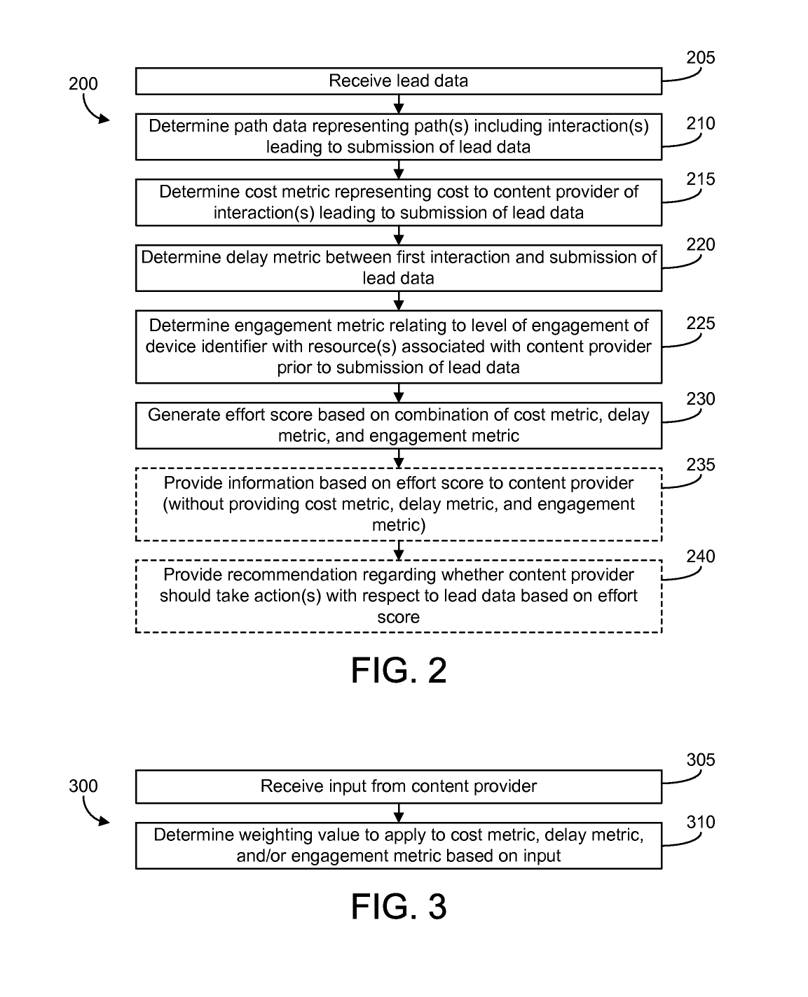

FIG. 2 illustrates a flow diagram of a process 200 for generating an effort score for a lead according to an illustrative implementation. Referring to both FIGS. 1 and 2, analysis system 150 may be configured to receive lead data 175 relating to one or more leads. Lead data 175 may include one or more pieces of information submitted by a user, who may be a potential customer of the content provider (e.g., a candidate to purchase a product/service from the content provider). Lead data 175 may include, for instance, a name of the user, address of the user, email address of the user, one or more characteristics of the user and/or the user device of the user, and/or other types of information. Lead data 175 may be submitted by the user via a resource including a data submission form, through a content item displayed to the user (e.g., an item including a field inviting the user to enter an email address), or in some other manner.

Analysis system 150 may be configured to receive path data 162 indicating one or more previous interactions of users with one or more resources (e.g., webpages, applications, etc.) and/or content items (e.g., paid and/or unpaid content items presented within resources) (210). Path data 162 may include a plurality of user paths, and one or more of the user paths may result in a lead submission 166 in which the user submits lead data 175. Each user path may have associated therewith a device identifier 168 identifying the user device of the user.

Path data 162 may also include one or more content interactions indicating one or more previous interactions of users with one or more content items, such as content items provided within a resource (e.g., within a content interface). In some such implementations, at least some of the content interactions may occur prior to lead submissions 166 within the user paths. For instance, a user may be presented with a content item promoting a particular product/service, and the user may click through the content item to reach a webpage through which the user may provide lead data 175 to receive additional product information or a discount. The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). A content campaign may include one or more content items that the content provider wishes to have presented to user devices 104 by content management system 108. In some implementations, some of the content items may be configured to invite the user to submit lead data 175, or may direct the user to a resource through which the user can submit lead data 175.

Path data 162 may include any type of data from which information about previous interactions of a user with content can be determined. The interactions may be instances where impressions of a campaign content item have been displayed on the user device of the user, instances where the user clicked through or otherwise selected the content item, instances where the user converted (e.g., provided lead data, purchased a product/service, etc.), and/or other types of interactions.

In some implementations, path data 162 may include resource visitation data collected by analysis system 150 describing some or all activities leading to a website or other resource of the content provider. Analysis system 150 may collect information relating to a portion of the resource visited/accessed, an identifier associated with the user device that accessed the resource, information relating to an origin or previous location that the user device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit or other user interaction with one or more content items of the content campaign. The result data may indicate whether the visit resulted in submission of lead data 175. In some implementations, the result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions (e.g., lead submissions and/or purchases) resulting from visits/interactions. The full path from a first user interaction to a converting action, such as provision of lead data 175 and/or a purchase, may be referred to as a conversion path. In some implementations, path data 162 may include data relating to multiple conversion paths and/or non-converting paths (e.g., paths ending with an action other than a conversion, such as an abandonment in which the user does not perform a converting action and has no further interaction with resources of the content provider).

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage.

In various implementations, a device identifier 168 may be a browser cookie, a unique device identifier (e.g., a serial number), a device fingerprint (e.g., collection of non-private characteristics of the user device), or another type of identifier. Device identifier 168 may not include personally identifiable data from which an actual identity of the user can be discerned. In some implementations, analysis system 150 may be configured to require consent from the user to tie device identifier 168 to path data 162. In some implementations, path data from multiple sources may be utilized even if the path data sets reference different types of identifiers. For example, paths may be joined by matching one identifier (e.g., browser cookie) with another identifier (e.g., a device identifier) to associate both path data sets as corresponding to a single user.

Analysis system 150 may be configured to determine a cost metric 182 representing a cost to the content provider of one or more interactions 164 leading to a lead submission 166 in which lead data 175 is received from a user device (215). Cost metric 182 may represent an estimated total cost expended by the content provider pursuing the lead thus far (e.g., as of the time of lead submission 166). In some implementations, cost metric 182 may be generated based on cost data associated with device identifier 168 and/or the user associated with device identifier 168 provided manually by the content provider. In some implementations, cost metric 182 may additionally or alternatively be determined based on cost data 170 associated with one or more interactions 164 in path data 162. In some such implementations, analysis system 150 may determine a cost associated with one or more of the interactions leading to lead submission 166 (e.g., one or more interactions in which the user device is presented with paid content items), such as based on cost data received from content management system 108 (e.g., based on data included in log files 114 of system 108). In some such implementations, analysis system 150 may determine cost metric 182 based on an aggregation (e.g., sum) of the costs associated with the individual interactions. In one illustrative implementation, prior to submitting lead data, a user may be presented with a first content item at a cost of $5.00, a second content item at a cost of $3.00, and a third content item at a cost of $0.50,and system 150 may determine cost metric 182 for the lead to be $8.50.

Analysis system 150 may also determine a delay metric 184 between a first interaction in the path and the lead submission 166 (220). Delay metric 184 may be indicative of an actual or relative amount of time that elapsed between the time of the first interaction and the time of lead submission 166. In some implementations, delay metric 184 may be or include a number of interactions between the first interaction and lead submission 166. In some implementations, delay metric 184 may be or include an actual amount of time between the first interaction and lead submission 166. In some such implementations, system 150 may determine delay metric 184 based on timing data 172 associated with interactions 164. For instance, timing data 172 for a particular interaction may include a time at which the interaction began (e.g., a time at which the device associated with device identifier 168 navigated to the resource associated with the interaction and/or was presented with the content item associated with the interaction), a time at which the interaction ended (e.g., a time at which the device associated with device identifier 168 navigated away from the resource and/or content item associated with the interaction), an interaction time associated with the interaction (e.g., an amount of time from the start of the interaction to the end of the interaction), and/or other types of timing information. In some implementations, system 150 may determine delay metric 184 based on timing data 172 for the first interaction and lead submission 166. For instance, if it is known that the most successful leads for a particular category (e.g., vertical or industry segment) are those in which lead submission 166 occurs between two and three weeks after the first interaction, system 150 may be configured to determine delay metric 184 to be highest for those leads exhibiting this timing relationship between the first interaction and lead submission 166.

Analysis system 150 may also determine an engagement metric 186 relating to a level of engagement of the user device (e.g., represented by device identifier 168) with one or more resources associated with the content provider prior to lead submission 166 (225). Engagement metric 186 may be determined based on a variety of factors associated with user behavior reflected in path data 162, according to various illustrative implementations. In some implementations, engagement metric 186 may be determine based at least in part on a number of interactions prior to lead submission 166 (e.g., when delay metric 184 is based on an elapsed time between the first interaction and lead submission 166).

In some implementations, engagement metric 186 may be based on an interaction time associated with one or more of the interactions leading to lead submission 166. In some such implementations, engagement metric 186 may be based on one or more longest or shortest interaction times of the interactions leading to lead submission 166. In some implementations, engagement metric 186 may be based on a combination (e.g., average, median, etc.) of the interaction times of the interactions leading to lead submission 166. In one such implementation, engagement metric 186 may be based on a total interaction time associated with the interactions (e.g., a sum of the interaction times associated with the interactions, such as based on timing data 172).

In some implementations, engagement metric 186 may be based in part on one or more characteristics and/or types of interactions leading to lead submission 186. In some illustrative implementations, one or more types of interactions may be known to increase or decrease a likelihood that a lead, if pursued, will successfully convert into a purchase. In one illustrative implementation, it may be known that the likelihood of an eventual purchase increases substantially if the user interacts with at least four webpages of the content provider prior to lead submission 166. In such an implementation, system 150 may determine engagement metric 186 to be higher for leads in which path data 162 indicates interaction with at least four webpages of the content provider prior to lead submissions 166, as compared to leads in which path data 162 indicates interaction with fewer than four webpages of the content provider.

System 150 may generate an effort score 180 based on a combination of cost metric 182, delay metric 184, and engagement metric 186 (230). Effort score 180 may be indicative of an amount of time and/or effort expended by the user in interacting with content related to the content provider prior to lead submission 166. In some implementations, effort score 180 may also be indicative of an investment the content provider has made in marketing to the user (e.g., cost and/or time the content provider has invested thus far in presenting content to the user device of the user). In some implementations, system 150 may apply an equal weighting to each metric when determining effort score 180 (e.g., each metric may be one-third of the determination of the final effort score 180). In some implementations, system 150 may apply weighting values 188 to generate effort score 180. Weighting values 188 may be configured to apply different emphasis to cost metric 182, delay metric 184, and engagement metric 186 when generating effort score 180. In one illustrative implementation, cost metric 182 may be given a weight of 50% and each of delay metric 184 and engagement metric 186 may be given a weight of 25% when determining effort score 180, emphasizing the cost the content provider has expended thus far in marketing to the user device in determining effort score 180. In another illustrative implementation, cost metric 182 may be given a weight of only 10%, delay metric may be given a weight of 30%, and engagement metric may be given a weight of 60%, emphasizing the level of engagement of the user device with resources associated with the content provider in determining effort score 180. In some implementations, additional metrics may be utilized to generate effort score 180, such as demographic data (e.g., age, gender, interest categories, etc.) and/or location data (e.g., region of world, distance from a store, etc.).

In some implementations, system 150 may provide information based on effort score 180 to the content provider (235). In some such implementations, system 150 may provide a relative effort indication based on effort score 180, such as high effort, medium effort, low effort, etc. System 150 may present the information based on effort score 180 without providing the underlying cost metric 182, delay metric 184, engagement metric 186, and/or other individualized data relating to a particular user to protect the privacy of the user.

In some implementations, system 150 may provide one or more recommendations 190 regarding whether the content provider should take one or more actions with respect to lead data 175 based on effort score 180 (240). In some such implementations, system 150 may provide an indication for each analyzed lead of whether or not it is recommended that the content provider pursue the lead further. In some implementations, system 150 may provide a relative indication of which leads should be pursued first, such as a list of leads ordered based on effort scores 180 of the leads. In some implementations, system 150 may provide a limited amount of underlying reasoning for each recommendation 190 (e.g., because a substantial amount of money has already been expended pursing the lead, because the lead has a high level of engagement, etc.) without providing the underlying metrics to the content provider.

In some implementations, system 150 may be configured to determine weighting values 188 to be applied in generating effort scores 180 based at least in part on input provided from a content provider. FIG. 3 illustrates a flow diagram of a process 300 for determining weighting values to be used in generating an effort score for a lead based on input from a content provider according to an illustrative implementation. Referring now to FIGS. 1 and 3, customization input 195 may be received from the content provider (305). System 150 may be configured to determine weighting values 188 to be applied to cost metric 182, delay metric 184, and/or engagement metric 186 for generating effort scores 180 based on customization input 195 (310). Customization input 195 may allow the content provider to customize the generation of effort score 180 to emphasize metrics that are of importance to the content provider and/or deemphasize the metrics that are of lesser importance to the content provider. In one illustrative implementation, if a content provider believes the time delay from a first interaction to lead submission 166 to be a significant indicator of the likelihood of success in pursuing leads, and is less concerned with the amount of money expended in pursuing leads, the content provider may provide customization input 195 causing system 150 to place increased emphasis on delay metric 184 and lesser emphasis on cost metric 182. In one illustrative implementation, a credit card company may look at time between first exposure and submission of a credit application as a representative proxy for credit risk, and may provide customization input 195 causing delay metric 184 to be weighted more heavily in generating effort score 180. In another illustrative implementation, an education provider may be most interested in where the user is in the process of converting, and may more heavily weight engagement metric 186 in generating effort score 180.

Customization input 195 may be any information that may be used by system 150 in determining a relative weight to be applied to the metrics used to generate effort score 180. In some implementations, customization input 195 may be an actual percentage or other weighting value to be applied directly to one or more of cost metric 182, delay metric 184, and/or engagement metric 186. In some implementations, customization input 195 may be information that may be used by system 150 to discern/infer a relative importance of one or more of metrics 182, 184, and/or 186 with respect to other metrics. In some such implementations, customization input 195 may be or include a selection of one or more items indicating that cost/delay/engagement is generally more or less important to the content provider, and analysis system may translate customization input 195 into a predetermined quantitative adjustment to weighting values 188. In one such illustrative implementation, if the content provider checks an input box indicating that engagement is important to the content provider, system 150 may increase a weight applied to engagement metric 186 by 15% when determining effort score 180.

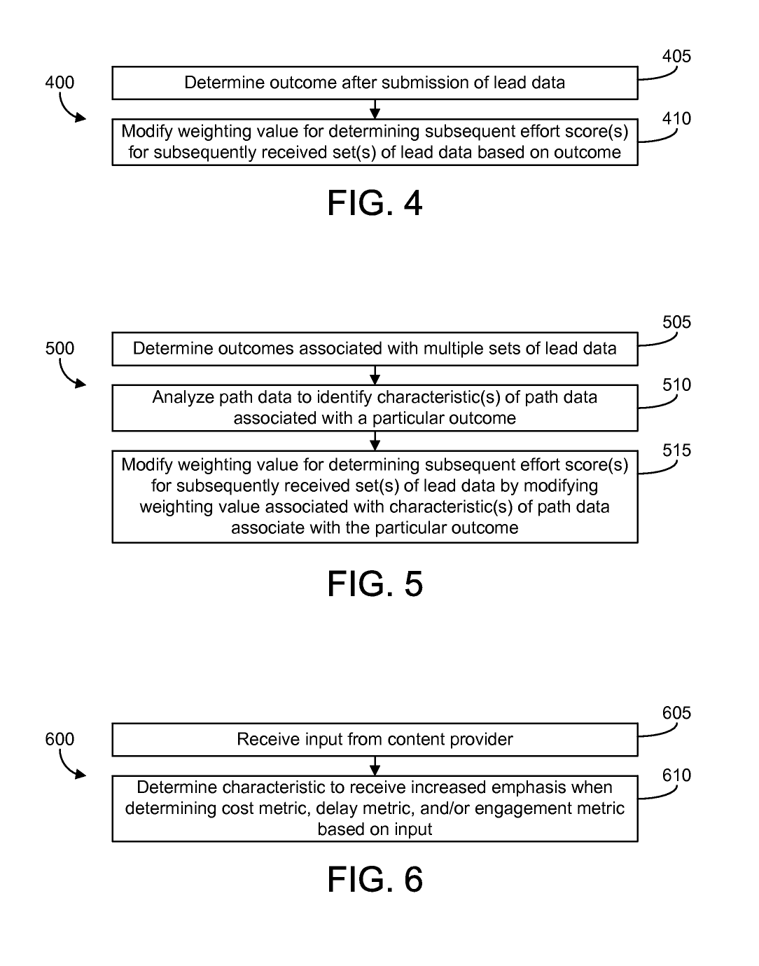

In some implementations, system 150 may be configured to determine outcomes associated with one or more leads and modify weighting values 188 based on the outcomes. FIG. 4 illustrates a flow diagram of a process 400 for modifying weighting values 188 based on a lead outcome according to an illustrative implementation. System 150 may determine an outcome of a lead after lead submission 166 when the content provider chooses to pursue the lead (405). The outcome may be any action of the user or lack thereof, such as a purchase of an item by the user, additional interactions by the user with resources associated with the content provider, an abandonment by the user in which the user does not interact further with resources of the content provider, and/or other types of interactions. In some implementations, the content provider may manually upload information about the outcomes of one or more leads to system 150. In some implementations, system 150 may additionally or alternatively be configured to automatically determine an outcome associated with one or more leads, such as through analysis of interactions 164 in path data 162 subsequent to lead submission 166.

System 150 may be configured to modify one or more of weighting values 188 for determining one or more subsequent effort scores 180 for subsequently received sets of lead data 175 based on the outcome of one or more leads (410). In one illustrative implementation, if a pursued lead is determined to have a successful outcome (e.g., a purchase), and that lead had a high cost metric 182, weighting values 188 may be modified to place increased emphasis on cost metric 182 when determining subsequent effort scores 180. In another illustrative implementation, if a pursued lead is determined to have an unsuccessful outcome (e.g., an abandonment), and that lead had a high delay metric 184, weighting values 188 may be modified to decrease the emphasis on delay metric 184 when determining subsequent effort scores 180.

FIG. 5 illustrates a flow diagram of a process 500 for modifying weighting values 188 based on path data characteristics associated with a particular lead outcome according to an illustrative implementation. System 150 may determine outcomes associated with multiple sets of lead data 175 for multiple leads (505). System 150 may analyze path data 162 associated with the sets of lead data 175 to identify one or more characteristics of the paths associated with a particular outcome (510). System 150 may be configured to identify one or more common characteristics associated with desirable outcomes (e.g., purchases, further engagement with the content provider, etc.) and/or undesirable outcomes (e.g., abandonments). In some implementations, system 150 may determine a characteristic to be associated with a particular outcome based on a number and/or percentage of the paths associated with the particular outcome in which the characteristic is present as compared to a number and/or percentage of the total paths in which the characteristic is present. In some such implementations, system 150 may determine the characteristic to be associated with the outcome if a difference in the number/percentage of paths associated with the outcome that include the characteristic and the number/percentage of total paths including the characteristic exceeds a threshold value. In one such implementation, if 35% of paths associated with leads that ultimately result in purchases include a visit to a travel website, only 15% of total paths associated with lead submissions 166 include a visit to the travel website, and the threshold difference for assessing characteristics is 15%, system 150 may determine that visits to the travel website are associated with leads having a relatively high percentage of subsequent purchases. In other implementations, system 150 may determine a characteristic to be associated with a particular outcome based on a number and/or percentage of the paths associated with the particular outcome in which the characteristic is present as compared to a number and/or percentage of the paths not associated with the particular outcome in which the characteristic is present.

System 150 may modify weighting values 188 for determining subsequent effort scores 180 for subsequently received sets of lead data 175 by modifying weighting values 188 related to the identified characteristics of path data 162 associated with a particular outcome (515). In the illustrative implementation provided in the paragraph above, system 150 may modify one or more weighting values 188 associated with visits to the travel website to generate increases efforts scores 180 for leads where path data 162 associated with the leads reflects that the user device has visited the travel website.

In some implementations, system 150 may be configured to allow the content provider to determine one or more characteristics the content provider wishes to be emphasized/deemphasized when determining effort scores 180. FIG. 6 is a flow diagram of a process for determining characteristics to be emphasized when determining metrics 182, 184, and/or 186 based on input from a content provider according to an illustrative implementation. System 150 may receive customization input 195 from the content provider (605). Customization input 195 may indicate one or more particular characteristics of metrics 182, 184, and/or 186 for which the content provider would like to place increased or decreased emphasis in determining effort scores 180. The characteristics may include any characteristics relevant to metrics 182, 184, and/or 186. In one illustrative implementation, the content provider may provide customization input 195 indicating that the content provider wishes to increase emphasis on leads where the user device navigated to a lead submission resource from a paid content item displayed within a search results interface. In another illustrative implementation, the content provider may provide customization input 195 indicating that the content provider wishes to increase emphasis on leads where the user device spent an average of at least four minutes engaging with webpages associated with the content provider. In one particular illustrative implementation, an automotive company may know that people who are looking at a financing webpage are closer to a purchase than those looking at a car building webpage, and may weight parameters of engagement metric 186 associated with engagement with a financing webpage more heavily in determining effort score 180.

Analysis system 150 may determine characteristics to receive increased emphasis when determining cost metric 182, delay metric 184, and/or engagement metric 186 based on customization input 195 (610). In the first illustrative implementation described in the paragraph above, system 150 may modify weighting values 188 associated with parameters of engagement metric 186 to increase effort scores 180 when lead submission 166 occurs immediately after the user device is presented with a paid content items within a search results interface. In the second illustrative implementation described in the paragraph above, system 150 may modify weighting values 188 associated with engagement metric 186 to increase effort scores 180 when path data 162 indicates the user has engaged with webpages associated with the content provider for an average of at least four minutes. In some implementations, efforts scores 180 may be utilized to modify one or more subsequent bids for paid content items to be displayed to users. In some such implementations, system 150 may determine that a device identifier 166 is associated with a high effort score 180. System 150 may transmit a message to content management system 108 configured to cause system 108 to modify (e.g., increase) one or more bids for content items to be displayed to a user device when the user device is associated with the device identifier 166. In such an implementation, system 150 may infer that the user is a high quality lead based on the high effort score 180, and may utilize the bid modification to more actively market content to the user.

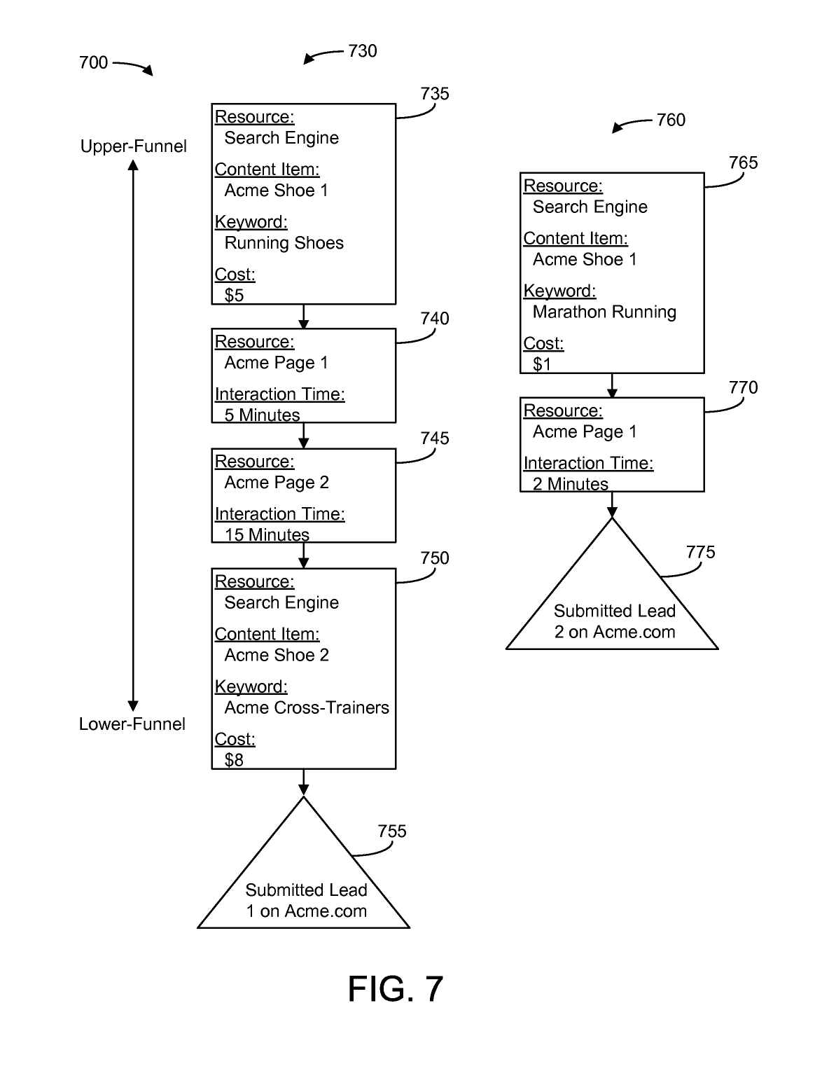

FIG. 7 provides an illustration of path data 700 according to an illustrative implementation. Referring now to FIGS. 1 and 7, a first path 730 includes four interactions leading to a lead submission 755. In first interaction 735, the user device is presented with a paid content item in response to entering a query of “Running Shoes” in a search engine interface, at a cost of $5 to the content provider. In interaction 740, the user device navigates to a webpage “Acme Page 1” and remains on the page for a duration of five minutes. The user device then navigates to a webpage “Acme Page 2,” where the user interacts with the page for a duration of 15 minutes (interaction 745). The user device subsequently navigates back to the search engine and enters a query of “Acme Cross-Trainers,” in response to which the user is presented with another paid content item at a cost of $8 to the content provider (interaction 750). Interaction 750 leads to a lead submission form on a webpage “Acme.com,” where the user submits the lead data.

A second path 760 includes two interactions leading to a second lead submission 775. In a first interaction 765 of path 760, a user device navigates to a search engine and enters a query “Marathon Running,” in response to which the user device is presented with a paid content item at a cost of $1 to the content provider. The user device is subsequently directed to the “Acme Page 1” webpage, with which the user interacts for a duration of two minutes (interaction 770). The user subsequently submits the second lead.

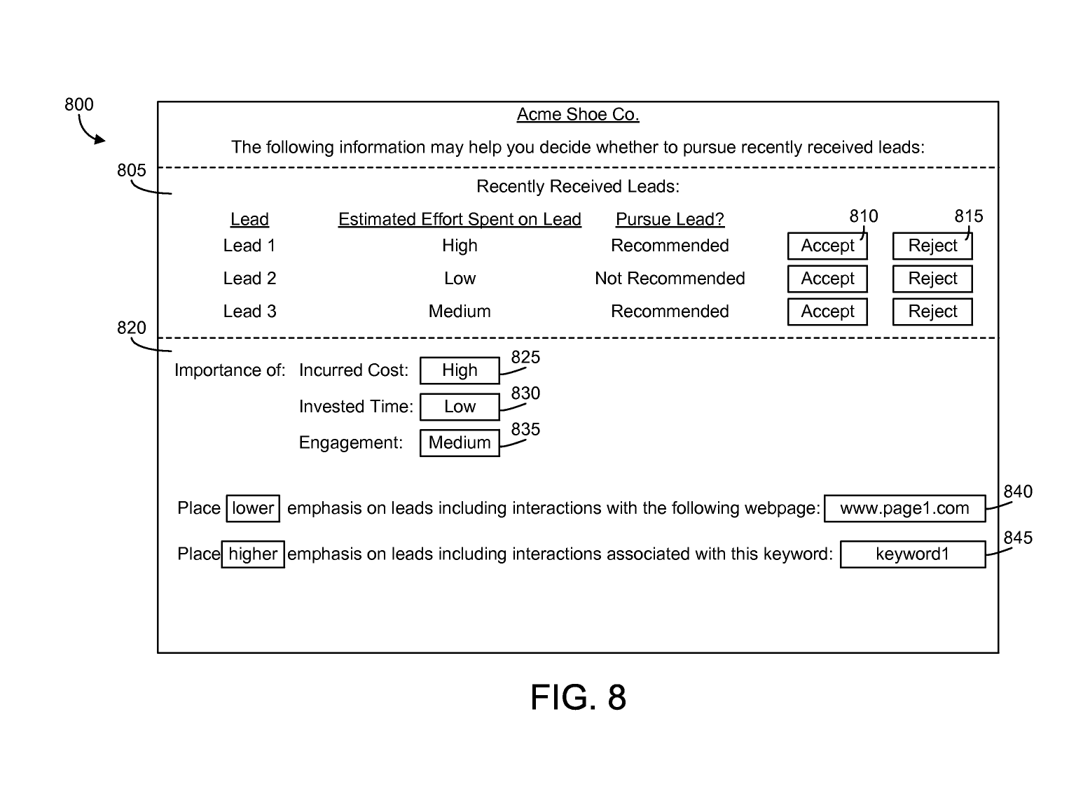

FIG. 8 is an illustration of a user interface 800 configured to present effort data associated with leads according to an illustrative implementation. FIG. 8 illustrates effort data that may be presented based on path data 700 shown in FIG. 7, according to one illustrative implementation. A lead evaluation portion 805 includes information relating to one or more recently received leads analyzed by system 150. In the illustrated implementation, system 150 provides an analysis of three leads including Lead 1 associated with path 730 and Lead 2 associated with path 760. System 150 provides information to the content provider indicating an estimated effort associated with each lead. In the illustrated implementation, the estimated effort is a relative level based on effort scores 180 (e.g., high, medium, low). System 150 reports that the relative effort associated with Lead 1 is high, which may be based on the relatively high cost expended on Lead 1 ($13), long delay between the first interaction 735 and lead submission 755 (three intervening interactions 740, 745, and 750), high amount of engagement time with resources of the content provider (at least 20 total minutes), and/or other factors. System 150 reports that the relative effort associated with Lead 2 is low, which may be based on the relative low cost expended on Lead 2($1), short delay between first interaction 765 and lead submission 775 (one interaction 770), low amount of engagement time with resources of the content provider (two minutes), and/or other factors.

In the illustrated implementation, system 150 also provides recommendations for whether the content provider should pursue each of the analyzed leads. In the illustrated implementation, system 150 recommends that the content provider pursue Lead 1 based on its high effort score and recommends that the content provider not pursue Lead 2 based on its low effort score. System 150 also recommends that the content provider pursue Lead 3, which has a medium effort score. In some implementations, system 150 may recommend that the content provider not pursue other leads having a medium effort score (e.g., when the raw effort score of Lead 3 is higher than the raw effort score of the other leads, despite the fact that both fall within a range of scores classified as “medium” effort levels). In some implementations, system 150 may allow the content provider to accept or reject the recommendation regarding whether to pursue the leads using accept button 810 and reject button 815. In some implementations, when the content provider clicks accept button 810, system 150 may transmit a message to a lead management system of the content provider to add the lead to a list of leads to be pursued, and when the content provider clicks reject button 815, system 150 may transmit a message to the lead management system to remove the lead from a list of leads being considered. In some implementations, system 150 may be configured to modify subsequent recommendations based on the feedback received via accept button 810 and reject button 815.

In some implementations, system 150 may provide a customization portion 820 configured to receive input from the content provider used in determining weighting parameters for generating efforts scores 180 for leads. In the illustrated implementation, an incurred cost customization field 825 allows the content provider to indicate whether cost metric 182 is of high/medium/low importance to the content provider, an invested time customization field 830 allows the content provider to indicate whether delay metric 184 is of high/medium/low importance, and an engagement customization field 835 allows the content provider to indicate whether engagement metric 186 is of high/medium/low importance. A resource customization field 840 allows the content provider to indicate whether lower/higher emphasis should be placed on leads including interactions with a particular resource (e.g., webpage). A keyword customization field 845 allows the content provider to indicate whether lower/higher emphasis should be placed on leads including interactions associated with a particular keyword (e.g., paid search-based items). Based on the input from the content provider in customization portion 820, system 150 may modify one or more related weighting values 188 used in generating effort scores 180 for subsequent leads.

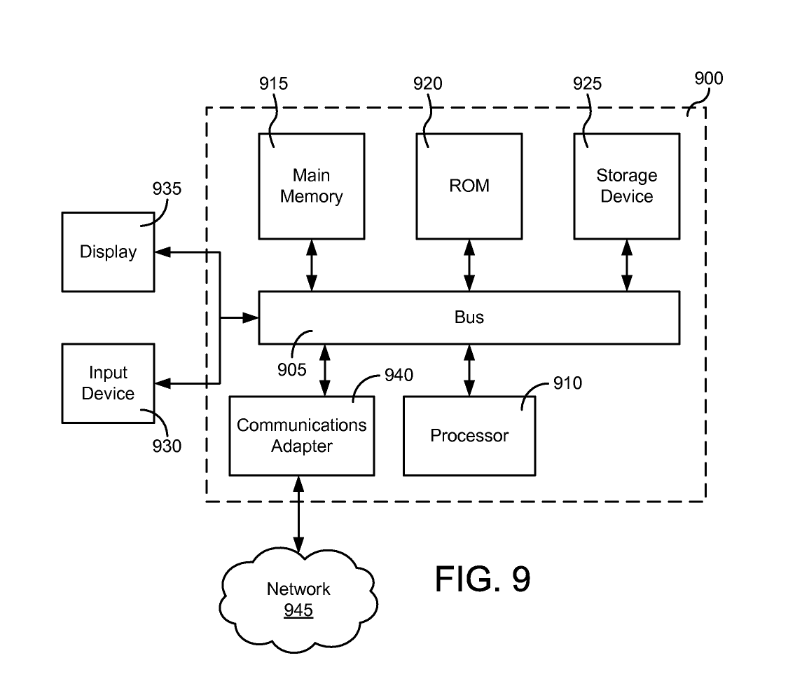

FIG. 9 illustrates a depiction of a computer system 900 that can be used, for example, to implement an illustrative user device 104, an illustrative content management system 108, an illustrative content provider device 106, an illustrative analysis system 150, and/or various other illustrative systems described in the present disclosure. The computing system 900 includes a bus 905 or other communication component for communicating information and a processor 910 coupled to the bus 905 for processing information. The computing system 900 also includes main memory 915, such as a random access memory (RAM) or other dynamic storage device, coupled to the bus 905 for storing information, and instructions to be executed by the processor 910. Main memory 915 can also be used for storing position information, temporary variables, or other intermediate information during execution of instructions by the processor 910. The computing system 900 may further include a read only memory (ROM) 910 or other static storage device coupled to the bus 905 for storing static information and instructions for the processor 910. A storage device 925, such as a solid state device, magnetic disk or optical disk, is coupled to the bus 905 for persistently storing information and instructions.

The computing system 900 may be coupled via the bus 905 to a display 935, such as a liquid crystal display, or active matrix display, for displaying information to a user. An input device 930, such as a keyboard including alphanumeric and other keys, may be coupled to the bus 905 for communicating information, and command selections to the processor 910. In another implementation, the input device 930 has a touch screen display 935. The input device 930 can include a cursor control, such as a mouse, a trackball, or cursor direction keys, for communicating direction information and command selections to the processor 910 and for controlling cursor movement on the display 935.

In some implementations, the computing system 900 may include a communications adapter 940, such as a networking adapter. Communications adapter 940 may be coupled to bus 905 and may be configured to enable communications with a computing or communications network 945 and/or other computing systems. In various illustrative implementations, any type of networking configuration may be achieved using communications adapter 940, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 900 in response to the processor 910 executing an arrangement of instructions contained in main memory 915. Such instructions can be read into main memory 915 from another computer-readable medium, such as the storage device 925. Execution of the arrangement of instructions contained in main memory 915 causes the computing system 900 to perform the illustrative processes described herein. One or more processors in a multi-processing arrangement may also be employed to execute the instructions contained in main memory 915. In alternative implementations, hard-wired circuitry may be used in place of or in combination with software instructions to implement illustrative implementations. Thus, implementations are not limited to any specific combination of hardware circuitry and software.

Although an example processing system has been described in FIG. 9, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized analysis system, lead data;
determining, by the analysis system, path data representing one or more paths comprising one or more interactions leading to submission of the lead data, the one or more interactions including a device identifier associated with a device;
determining, by the analysis system, a cost metric representing a cost to a content provider of the one or more interactions leading to submission of the lead data;
determining, by the analysis system, a delay metric between a first interaction of the one or more interactions and submission of the lead data;
determining, by the analysis system, an engagement metric relating to a level of engagement of the device identifier with one or more resources associated with the content provider prior to submission of the lead data; and
generating, by the analysis system, an effort score based on a combination of the cost metric, the delay metric, and the engagement metric.

2. The method of claim 1, further comprising providing a recommendation regarding whether the content provider should take one or more actions with respect to the lead data based on the effort score.

3. The method of claim 1, wherein the cost metric is determined based on one or more interaction costs of one or more of the interactions obtained from the path data, and wherein, when the path data includes a plurality of interaction costs, determining the cost metric comprises aggregating the plurality of interactions costs.

4. The method of claim 1, wherein the delay metric comprises at least one of a time delay between the first interaction and submission of the lead data or a number of interactions between the first interaction and submission of the lead data.

5. The method of claim 1, wherein the engagement metric is determined based on at least one of a number of interactions prior to submission of the lead data, an interaction time associated with one or more of the interactions, or a total interaction time associated with the one or more interactions.

6. The method of claim 1, further comprising providing information based on the effort score to the content provider without providing the cost metric, the delay metric, and the engagement metric.

7. The method of claim 1, wherein the effort score is generated based on a weighted combination of the cost metric, the delay metric, and the engagement metric, and wherein the method further comprises:
receiving input from the content provider; and
determining a weighting value to apply to at least one of the cost metric, the delay metric, and the engagement metric based on the input from the content provider.

8. The method of claim 7, further comprising:
determining an outcome after submission of the lead data; and
modifying the weighting value for determining one or more subsequent effort scores for one or more subsequently received sets of lead data based on the outcome.

9. The method of claim 7, further comprising:
determining outcomes associated with a plurality of sets of lead data;
analyzing path data relating to the plurality of devices to identify one or more characteristics of the path data associated with a particular outcome; and
modifying the weighting value for determining the one or more subsequent effort scores for the one or more subsequently received sets of lead data by modifying a weighting value associated with the one or more characteristics of the path data associated with the particular outcome.

10. The method of claim 1, wherein at least one of the cost metric, the delay metric, and the engagement metric comprises a plurality of characteristics, and wherein the method further comprises:
receiving input from the content provider; and
determining a first characteristic of the plurality of characteristics to receive increased emphasis when determining the at least one of the cost metric, the delay metric, and the engagement metric based on the input from the content provider.

11. The method of claim 1, further comprising determining whether to cause a bid for presenting one or more paid content items on the device to be modified based on the effort score.

12. A system comprising:
at least one computing device operably coupled to at least one memory and configured to:
receive lead data;
determine path data representing one or more paths comprising one or more interactions leading to submission of the lead data, the one or more interactions including a device identifier associated with a device;
determine a cost metric representing a cost to a content provider of the one or more interactions leading to submission of the lead data;
determine a delay metric between a first interaction of the one or more interactions and submission of the lead data;
determine an engagement metric relating to a level of engagement of the device identifier with one or more resources associated with the content provider prior to submission of the lead data; and
generate an effort score based on a combination of the cost metric, the delay metric, and the engagement metric.

13. The system of claim 12, wherein the at least one computing device is further configured to provide a recommendation regarding whether the content provider should take one or more actions with respect to the lead data based on the effort score.

14. The system of claim 12, wherein:
the cost metric is determined based on one or more interaction costs of one or more of the interactions obtained from the path data;
the delay metric comprises at least one of a time delay between the first interaction and submission of the lead data or a number of interactions between the first interaction and submission of the lead data; and
the engagement metric is determined based on at least one of a number of interactions prior to submission of the lead data, an interaction time associated with one or more of the interactions, or a total interaction time associated with the one or more interactions.

15. The system of claim 12, wherein the effort score is generated based on a weighted combination of the cost metric, the delay metric, and the engagement metric, and wherein the at least one computing device is further configured to:
receive input from the content provider; and
determine a weighting value to apply to at least one of the cost metric, the delay metric, and the engagement metric based on the input from the content provider.

16. The system of claim 15, wherein the at least one computing device is further configured to:
determine an outcome after submission of the lead data; and
modify the weighting value for determining one or more subsequent effort scores for one or more subsequently received sets of lead data based on the outcome.

17. The system of claim 15, wherein the at least one computing device is further configured to:
determine outcomes associated with a plurality of sets of lead data;
analyze path data relating to the plurality of devices to identify one or more characteristics of the path data associated with a particular outcome; and
modify the weighting value for determining the one or more subsequent effort scores for the one or more subsequently received sets of lead data by modifying a weighting value associated with the one or more characteristics of the path data associated with the particular outcome.

18. One or more computer-readable storage media having instructions stored thereon that, when executed by at least one processor, cause the at least one processor to perform operations comprising:
receiving lead data;
determining path data representing one or more paths comprising one or more interactions leading to submission of the lead data, the one or more interactions including a device identifier associated with a device;
determining a cost metric representing a cost to a content provider of the one or more interactions leading to submission of the lead data, wherein the cost metric is determined based on one or more interaction costs of one or more of the interactions obtained from the path data, and wherein, when the path data includes a plurality of interaction costs, determining the cost metric comprises aggregating the plurality of interactions costs;
determining a delay metric between a first interaction of the one or more interactions and submission of the lead data, wherein the delay metric comprises at least one of a time delay between the first interaction and submission of the lead data or a number of interactions between the first interaction and submission of the lead data;
determining an engagement metric relating to a level of engagement of the device identifier with one or more resources associated with the content provider prior to submission of the lead data, wherein the engagement metric is determined based on at least one of a number of interactions prior to submission of the lead data, an interaction time associated with one or more of the interactions, or a total interaction time associated with the one or more interactions; generating an effort score based on a combination of the cost metric, the delay metric, and the engagement metric; and
providing a recommendation regarding whether the content provider should take one or more actions with respect to the lead data based on the effort score.

19. The one or more computer-readable storage media of claim 18, wherein the effort score is generated based on a weighted combination of the cost metric, the delay metric, and the engagement metric, and wherein the operations further comprise:
receiving input from the content provider; and
determining a weighting value to apply to at least one of the cost metric, the delay metric, and the engagement metric based on the input from the content provider.

20. The one or more computer-readable storage media of claim 18, wherein at least one of the cost metric, the delay metric, and the engagement metric comprises a plurality of characteristics, and wherein the operations further comprise:
receiving input from the content provider; and
determining a first characteristic of the plurality of characteristics to receive increased emphasis when determining the at least one of the cost metric, the delay metric, and the engagement metric based on the input from the content provider.
